(19) United States
(12) Patent Application Publication
(10) Pub. No.: US 2013/0332690 A1
(43) Pub. Date: Dec. 12, 2013

(54) Memory Systems and Memory Managing Methods of Managing Memory in a Unit of Memory Chunk

(71) Applicants: SAMSUNG ELECTRONICS CO., LTD., Suwon-si (KR); RESEARCH & BUSINESS FOUNDATION SUNGKYUNKWAN UNIVERSITY, Suwon-si (KR)

(72) Inventors: Dong-Young Seo, Seoul (KR); Dongkun Shin, Seoul (KR)

(73) Assignees: Research & Business Foundation Sungkyunkwan University, Suwon-si (KR); Samsung Electronics Co., Ltd., Suwon-si (KR)

(21) Appl. No.: 13/832,144

(22) Filed: Mar. 15, 2013

(30) Foreign Application Priority Data
Jun. 12, 2012 (KR) 10-2012-0062811

(51) Int. Cl. G06F 3/06

(52) U.S. Cl. CPC G06F 3/0631
USPC 711/170

(57) ABSTRACT

A method of managing a memory by a unit of memory chunk is provided. The method includes managing multiple memory chunks according to a chunk tree structure, managing program frequencies of the memory chunks of the memory according to a program of the memory, and allocating the memory chunks based on the program frequencies and the chunk tree structure.

### CROSS-REFERENCE TO RELATED APPLICATIONS

A claim for priority under 35 U.S.C. §119 is made to Korean Patent Application No. 10-2012-0062811 filed Jun. 12, 2012, in the Korean Intellectual Property Office, the entire contents of which are hereby incorporated by reference.

### BACKGROUND

The inventive concepts described herein relate to semiconductor memory devices, and more particularly, relate to memory managing methods capable of managing a memory in a unit of memory chunk.

An operating system driven at a memory system may manage a memory using a memory manager. The memory manager may include a buddy memory allocator, a slab memory allocator, and so on.

A typical memory manager may operate based on a dynamic random access memory (DRAM). The DRAM may be characterized in that it is slightly worn by programming and erasing. Thus, the typical memory manager may not manage a memory in view of a wear-level of the memory.

In recent years, a storage class RAM (hereinafter, referred to as SCRAM) may have been researched with a view to replacing the DRAM. The SCRAM may include nonvolatile memories such as a ferroelectric RAM (FRAM), a magnetic RAM (MRAM), a phase-change RAM (PRAM), a resistive RAM (RRAM), and so on.

### SUMMARY

Some embodiments of the present inventive concept are directed to methods of managing a memory including multiple memory chunks according to a chunk tree structure. Such methods may include managing program frequencies of the memory chunks of the memory according to a program of the memory, managing allocation information of ones of the memory chunks in the chunk tree structure, and allocating the memory chunks based on the program frequencies and the allocation information.

In some embodiments, managing the program frequencies of the memory chunks includes receiving a program interrupt and a program address from a memory controller that controls the memory and increasing a program frequency of the lowest memory chunk corresponding to the program address. Some embodiments provide that the program interrupt and the program address are received when a program frequency of the memory reaches a threshold value and that the program address corresponds to a program executed when the program frequency reaches the threshold value.

In some embodiments, the memory chunks include a parent memory chunk and multiple child memory chunks that are included in the parent memory chunk. Managing the program frequencies of the memory chunks may include setting a program frequency of the parent memory chunk to a sum of program frequencies of the child memory chunks. Some embodiments provide that managing the program frequencies of the memory chunks includes setting a program frequency of the parent memory chunk to a sum of program frequencies of a non-allocated one of the child memory chunks. In some embodiments, managing the program frequencies of the memory chunks includes setting a program frequency of the parent memory chunk to double the program frequency of a non-allocated one of the child memory chunks.

Some embodiments provide that managing the program frequencies of the memory chunks includes detecting a smallest program frequency and a largest program frequency of program frequencies of the memory chunks at a lowest level of the chunk tree structure, determining whether a difference between the smallest program frequency and the largest program frequency reaches a threshold value, if the difference between the smallest program frequency and the largest program frequency reaches the threshold value, exchanging data and allocation between memory chunks having the smallest program frequency and the largest program frequency.

In some embodiments, managing allocation information of ones of the memory chunks in the chunk tree structure includes detecting allocation of at least one memory chunk of the memory chunks and setting a first allocation bit associated with the allocated memory chunk to indicate allocation. In some embodiments, the first allocation bit of each of the memory chunks indicates whether an associated one of the memory chunks is allocated. Some embodiments provide that managing allocation information includes setting a second allocation bit of the allocated memory chunk. The second allocation bit may indicate whether all memory chunks at each of lower levels relative to the associated memory chunk are allocated.

Some embodiments further include setting at least one first allocation bit of an upper memory chunk to allocation when the at least one of first allocation bits associated with the upper memory chunks of the allocated memory chunk indicates non-allocation. In some embodiments, when all memory chunks at one level of the chunk tree structure are allocated, second allocation bits are set indicating the level including the memory chunks allocated to indicate allocation at upper memory chunks relative to the level. Each of the second allocation bits may indicate whether all memory chunks at each of lower levels associated with a corresponding memory chunk are allocated.

Some embodiments include receiving a memory allocation request, accessing allocation bits associated with a root memory chunk, located at a highest level, from among the memory chunks, searching a target level, including an unallocated memory chunk having a size equal to or larger than a size corresponding to the memory allocation request, from among levels of the chunk tree structure based on the allocation bits, and allocating a memory chunk at the target level according to the chunk tree structure and the program frequencies.

In some embodiments, allocating the memory chunk at the target level according to the chunk tree structure and the program frequencies includes allocating the unallocated memory chunk when an unallocated memory chunk exists at the target level, and when two or more unallocated memory chunks exist at the target level, sequentially selecting a child memory chunk, having an allocation bit indicating that an unallocated memory chunk exists at the target level and that includes a small program frequency relative to other memory chunks at the same level until reaching the target level from the root memory chunk and allocating a memory chunk selected at the target level.

Example embodiments of the inventive concept provide a method of managing a memory by a unit of memory chunk, comprising managing a plurality of memory chunks according to a chunk tree structure; managing program frequencies of the plurality of memory chunks of the memory according to a program of the memory; and allocating the plurality of memory chunks based on the program frequencies and the chunk tree structure.

In example embodiments, the managing program frequencies of the plurality of memory chunks of the memory according to a program of the memory comprises receiving a program interrupt and a program address; and increasing a program frequency of the lowest memory chunk corresponding to the program address.

In example embodiments, the program interrupt and the program address are received from a controller of the memory.

In example embodiments, the program interrupt and the program address are received when a program frequency of the memory reaches a threshold value and the program address corresponds to a program executed when the program frequency reaches the threshold value.

In example embodiments, the managing program frequencies of the plurality of memory chunks of the memory according to a program of the memory further comprises setting a program frequency of a patent memory chunk, in which all child memory chunks are allocated, from among the plurality of memory chunks to a sum of program frequencies of the child memory chunks.

In example embodiments, the managing program frequencies of the plurality of memory chunks of the memory according to a program of the memory further comprises setting a program frequency of a patent memory chunk, in which all child memory chunks are not allocated, from among the plurality of memory chunks to a sum of program frequencies of the child memory chunks.

In example embodiments, the managing program frequencies of the plurality of memory chunks of the memory according to a program of the memory further comprises setting a program frequency of a patent memory chunk, in which a child memory chunk is allocated and a child memory chunk is not allocated, from among the plurality of memory chunks to the double of the program frequency of the child memory chunk not allocated.

In example embodiments, the managing program frequencies of the plurality of memory chunks of the memory according to a program of the memory comprises detecting the smallest program frequency and the largest program frequency of program frequencies of memory chunks at the lowest level of the chunk tree structure; determining whether a difference between the smallest program frequency and the largest program frequency reaches a threshold value; and if the difference between the smallest program frequency and the largest program frequency reaches the threshold value, exchanging data and allocation between memory chunks having the smallest program frequency and the largest program frequency.

In example embodiments, the managing a plurality of memory chunks according to a chunk tree structure comprises detecting allocation of at least one memory chunk of the plurality of memory chunks; and setting a first allocation bit associated with the allocated memory chunk to indicate allocation. A first allocation bit of each of the plurality of memory chunks indicates whether an associated memory chunk is allocated.

In example embodiments, the managing a plurality of memory chunks according to a chunk tree structure further comprises setting second allocation bits of the allocated memory chunk, and each of second allocation bits of the plurality of memory chunks indicates whether all memory chunks at each of lower levels associated with a corresponding memory chunk are allocated.

In example embodiments, the managing a plurality of memory chunks according to a chunk tree structure further comprises setting at least one first allocation bit of an upper memory chunk to allocation when the at least one of first allocation bits associated with the upper memory chunks of the allocated memory chunk indicates non-allocation.

In example embodiments, the managing a plurality of memory chunks according to a chunk tree structure further comprises when all memory chunks at one of levels of the chunk tree structure are allocated, setting second allocation bits indicating the level including the memory chunks allocated to indicate allocation at upper memory chunks of the level, and each of second allocation bits of the plurality of memory chunks indicates whether all memory chunks at each of lower levels associated with a corresponding memory chunk are allocated.

In example embodiments, the managing a plurality of memory chunks according to a chunk tree structure comprises receiving a memory allocation request; accessing allocation bits associated with a root memory chunk, located at the highest level, from among the plurality of memory chunks; searching a target level, including an unallocated memory chunk having a size equal to or larger than a size corresponding to the memory allocation request, from among levels of the chunk tree structure based on the allocation bits; and allocating a memory chunk at the target level according to the chunk tree structure and the program frequencies.

In example embodiments, the allocating a memory chunk at the target level according to the chunk tree structure and the program frequencies comprises allocating the unallocated memory chunk when an unallocated memory chunk exists at the target level; and when two or more unallocated memory chunks exist at the target level, sequentially selecting a child memory chunk, having an allocation bit indicating that an unallocated memory chunk exists at the target level and having a relatively small program frequency, from among child memory chunks until reaching the target level from the root memory chunk and allocating a memory chunk selected at the target level.

Example embodiments of the inventive concept also provide a memory system comprising a memory; a controller configured to control the memory; and a processor configured to manage the memory according to a chunk tree structure, wherein the controller is configured to generate a program interrupt whenever a program of the memory is performed by a threshold value; and wherein the processor is configured to manage program frequencies of a plurality of memory chunks of the memory based on the program interrupt and to allocate the plurality of memory chunks based on the chunk tree structure and the program frequencies.

It is noted that aspects of the inventive concept described with respect to one embodiment, may be incorporated in a different embodiment although not specifically described relative thereto. That is, all embodiments and/or features of any embodiment can be combined in any way and/or combination. These and other objects and/or aspects of the present inventive concept are explained in detail in the specification set forth below.

### BRIEF DESCRIPTION OF THE FIGURES

The above and other objects and features will become apparent from the following description with reference to the following figures, wherein like reference numerals refer to like parts throughout the various figures unless otherwise specified.

FIG. 1 is a block diagram schematically illustrating a memory system according to some embodiments of the inventive concept.

FIG. 2 is a diagram schematically illustrating the software architecture of a memory system 100 in FIG. 1.

FIGS. 3A to 3D are graphs illustrating memory programs generated according to an execution of an application when an SCRAM is managed by a typical memory manager.

FIG. 4 is a flow chart illustrating a memory managing method according to some embodiments of the inventive concept.

FIG. 5 is a diagram illustrating a memory managing method of a memory manager according to some embodiments of the present inventive concept.

FIG. 6 is a flow chart illustrating a memory managing method of some embodiments of the inventive concept in which memory chunks are managed according to a chunk tree memory.

FIG. 7 is a flow chart illustrating a method of managing program frequencies of memory chunks according to a program frequency managing method of embodiments of the inventive concept.

FIG. 8 is a diagram illustrating an example in which memory chunks are managed according to a memory chunk managing method in FIG. 6 and a program frequency managing method in FIG. 7.

FIG. 9 is a flow chart indicating a memory chunk allocating method according to some embodiments of the inventive concept.

FIG. 10 is a detailed flow chart indicating a method of allocating a memory chunk of a target level in FIG. 9.

FIGS. 11 to 16 are diagrams illustrating an example in which memory chunks are allocated and released according to a chunk tree managing method in FIG. 6, a program frequency managing method in FIG. 7, and a memory chunk allocating method in FIG. 10.

FIG. 17 is a flow chart illustrating an embodiment of a method in which a controller in FIG. 1 transfers a program interrupt and a program address.

FIG. 18 is a flow chart illustrating an embodiment in which wear levels of allocated memory chunks are managed.

FIG. 19 is a diagram illustrating an example in which a wear level is managed according to a managing method in FIG. 18.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

Memory chunks of a chunk tree structure will be described with reference to a root memory chunk, a parent memory chunk, a child memory chunk, a higher memory chunk, and a lower memory chunk. The root memory chunk may indicate a memory chunk located at the uppermost level of the chunk tree structure. The parent memory chunk may indicate a memory chunk which is located at a level just above a memory chunk being described and has correlation with each other. The child memory chunk may indicate a memory chunk which is located at a level just below a memory chunk being described and has correlation with each other. The higher memory chunk may indicate a memory chunk which is located at a level above a memory chunk being described and has correlation with each other. The higher memory chunk may include the parent memory chunk and a grandparent memory chunk. The lower memory chunk may indicate a memory chunk which is located at a level below a memory chunk being described and has correlation with each other. The lower memory chunk may include the child memory chunk and a grandson memory chunk. Memory chunks having correlation may indicate memory chunks belonging to the same branch of branches diverged from the root memory chunk.

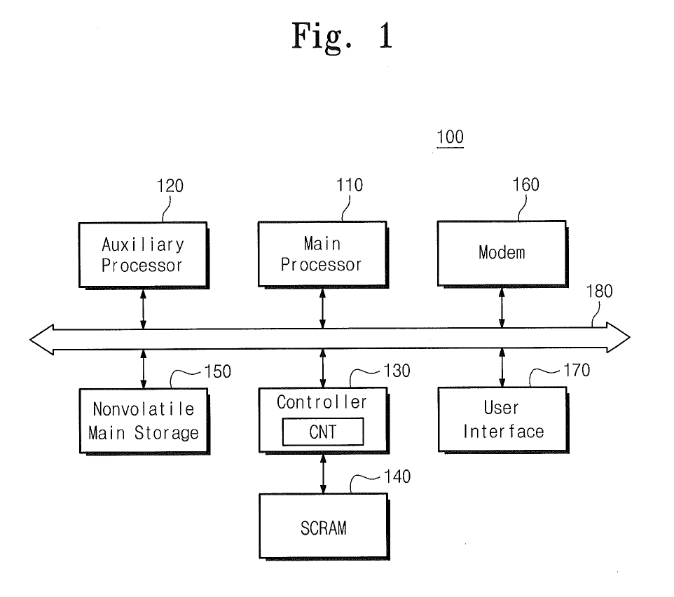

FIG. 1 is a block diagram schematically illustrating a memory system according to some embodiments of the inventive concept. Referring to FIG. 1, a memory system 100 may include a main processor 110, an auxiliary processor 120, a controller 130, a storage class RAM (SCRAM) 140, a nonvolatile main storage 150, a modem 160, a user interface 170, and a system bus 180.

The main processor 110 may be configured to control an overall operation of the memory system 100. The main processor 110 may include a general-purpose processor and/or an application processor, among others.

The auxiliary processor 120 may assist computation of the main processor 110. The auxiliary processor 120 may include a graphic processing unit (GPU) or an image signal processor (ISP). The auxiliary processor 120 may include a general-purpose processor or an application processor which constitutes a dual core or more core processor system with the main processor 110.

The controller 130 may control the SCRAM 140 in response to a command and an address transferred via the system bus 180. The command and address can be received from the main processor 110, the auxiliary processor 120, or at least one of other constituent elements. The controller 130 may control a read operation, a write operation, an erase operation, and/or a background operation of the SCRAM140. The controller 130 may write data transferred via the system bus 180 at the SCRAM 140, and may output data transferred from the SCRAM 140 to the system bus 180.

The controller 130 may include a counter CNT. The counter CNT may count a frequency of write commands transferred via the system bus 180. If a count value reaches a threshold value, the controller 130 may generate program interrupt. The controller 130 may output program address (that may be transferred when a count value reaches a threshold value) to the system bus 180 together with the program interrupt.

The SCRAM 140 may be a working memory of the memory system 100. The SCRAM 140 may include nonvolatile memories such as a ferroelectric RAM (FRAM), a magnetic RAM (MRAM), a phase-change RAM (PRAM), and/or a resistive RAM (RRAM), among others. The SCRAM 140 may have such a characteristic that it is worn according to execution of a program operation.

The nonvolatile main storage 150 may be a main storage of the memory system 100. The nonvolatile main storage 150 may include a HDD or a nonvolatile storage such as a NAND flash memory.

The modem 160 may communicate with an external device by wireless or wire. The modem 160 may communicate on the basis of at least one of a variety of communication methods such as Ethernet, WiFi, Long Term Evolution (LTE), Near Field Communication (NFC), and/or Bluetooth, among others.

The user interface 170 may exchange signals with a user. The user interface 170 may include user input interfaces such as a keyboard, a mouse, a camera, a microphone, a button, a touch pad, a touch screen, and so on and user output interfaces such as a monitor, a liquid crystal display, a beam projector, a speaker, a monitor, and so on.

The system bus 180 may provide a channel among constituent elements of the memory system 100.

A part of the constituent elements of the memory system 100 may be implemented by a system-on chip (SoC).

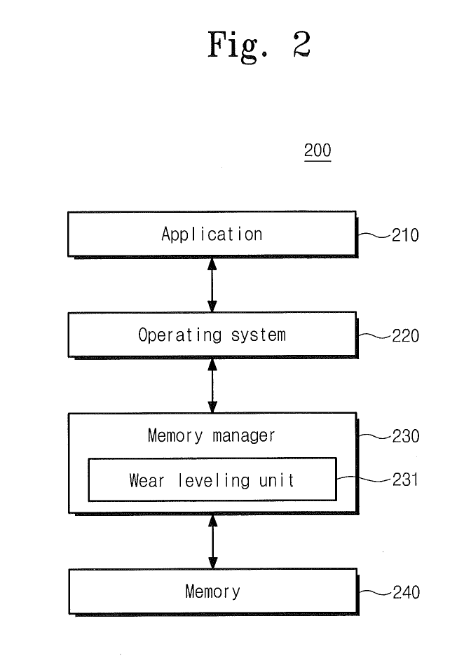

FIG. 2 is a diagram schematically illustrating the software architecture of a memory system 100 in FIG. 1. Referring to FIGS. 1 and 2, the software architecture may include an application 210, an operating system 220, a memory manager 230, and a memory 240.

The memory 240 may be an SCRAM 140.

The memory manager 230 may be configured to manage the memory 240. The memory manager 230 may manage the memory 240 by a unit of memory chunk. The memory manager 230 may separate the memory 240 into a plurality of memory chunks, and may form a chunk tree structure based on the plurality of memory chunks. The memory manager 230 may allocate and release chunks of the memory 240 based on the chunk tree structure.

The memory manager 230 may include a wear leveling unit 231. The wear-leveling unit 231 may be configured to manage wear-levels of the plurality of memory chunks, respectively. The memory manager 230 may allocate and release memory chunks based on wear levels managed by the wear leveling unit 231 and the chunk tree structure.

The operating system 220 may control an overall operation of the memory system 100. The operating system 220 may control constituent elements of the memory system 100, and may provide a condition in which the application 210 is driven. The operating system 220 may request the memory manager 230 to allocate and release the memory 240.

The application 210 may include a variety of software which is driven at a condition provided by the operating system 220. For example, the application 210 may include a word processor, a database, a spread sheet, an office, a game, and/or a multimedia reproduction program, among others.

The memory manager 230, the operating system 220, and the application 210 may be driven by the main processor 110 and/or by the main processor 110 and an auxiliary processor 120.

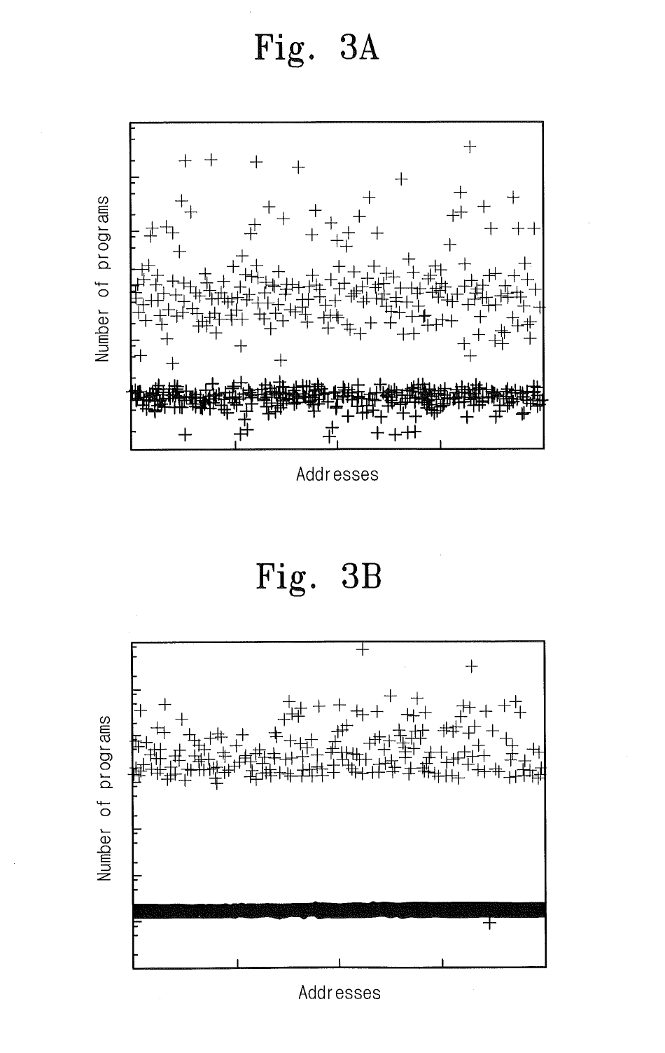

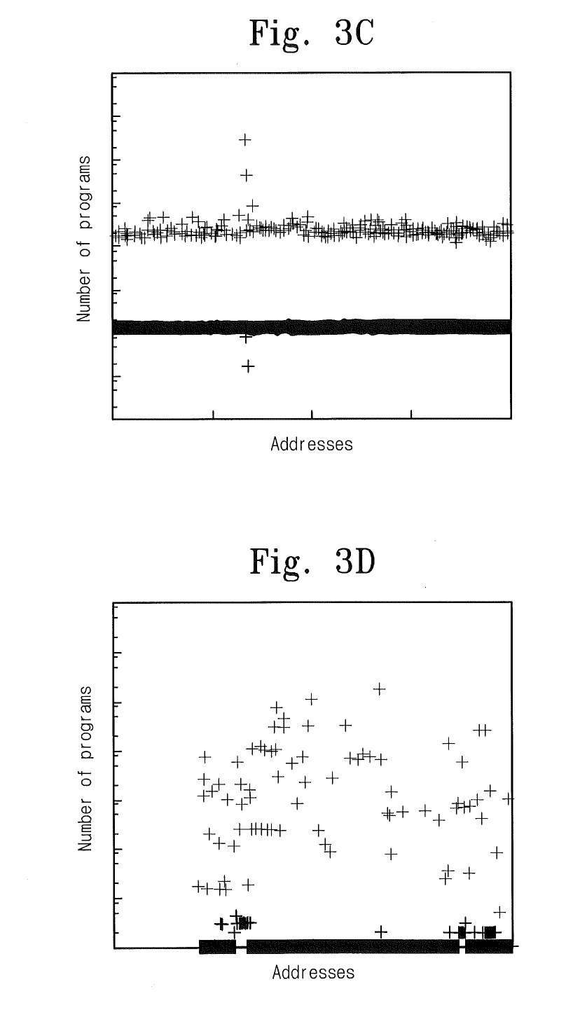

FIGS. 3A to 3D are graphs illustrating memory programs generated according to an execution of an application when an SCRAM is managed by a typical memory manager. In FIGS. 3A to 3D, a horizontal axis may indicate a memory address, and a vertical axis may indicate a program frequency.

FIG. 3A shows memory accesses generated when Firefox as one of the web search engines is executed. FIG. 3B shows memory accesses generated when a Linux kernel build is executed. FIG. 3C shows memory accesses generated when a sort is executed. FIG. 3D shows memory accesses generated when vi, a test editor, is executed.

Referring to FIGS. 1, 2, and 3A to 3D, when a memory is managed by a typical memory manager, a program frequency may differentiate according to addresses of the memory. In a memory system in which a DRAM is replaced with an SCRAM 140, a difference between program frequencies may cause a difference between wear levels. This may mean that a life of the SCRAM 140 is shortened. Accordingly, a life of the memory system 100 may be shortened and the reliability thereof may be lowered.

The memory system 100 and the memory manager 230 may be configured to manage wear-leveling and to allocate memory chunks based on the wear-leveling. Thus, it is possible to provide the memory system 100 having improved life and reliability.

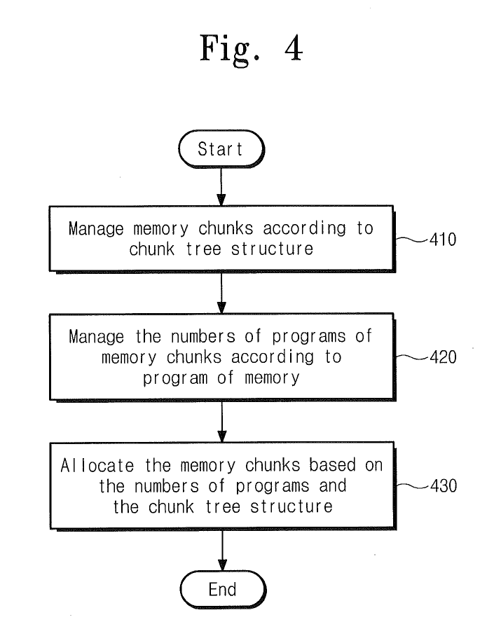

FIG. 4 is a flow chart illustrating a memory managing method according to an embodiment of the inventive concept. Referring to FIGS. 2 and 4, in operation 410, memory chunks may be managed according to the chunk tree structure. A memory manager 230 may manage a memory 240 based on the chunk memory structure.

In operation 420, the number of programs of the memory chunks may be managed according to a program of the memory 240. As a program of the memory 240 is generated, the memory manager 230 may manage program frequencies of chunks of the memory 240, respectively.

In operation 430, memory chunks may be allocated according to the program frequencies and the chunk tree structure. The memory manager 230 may allocate the memory chunks based on the program frequencies of the memory chunks and the chunk tree structure.

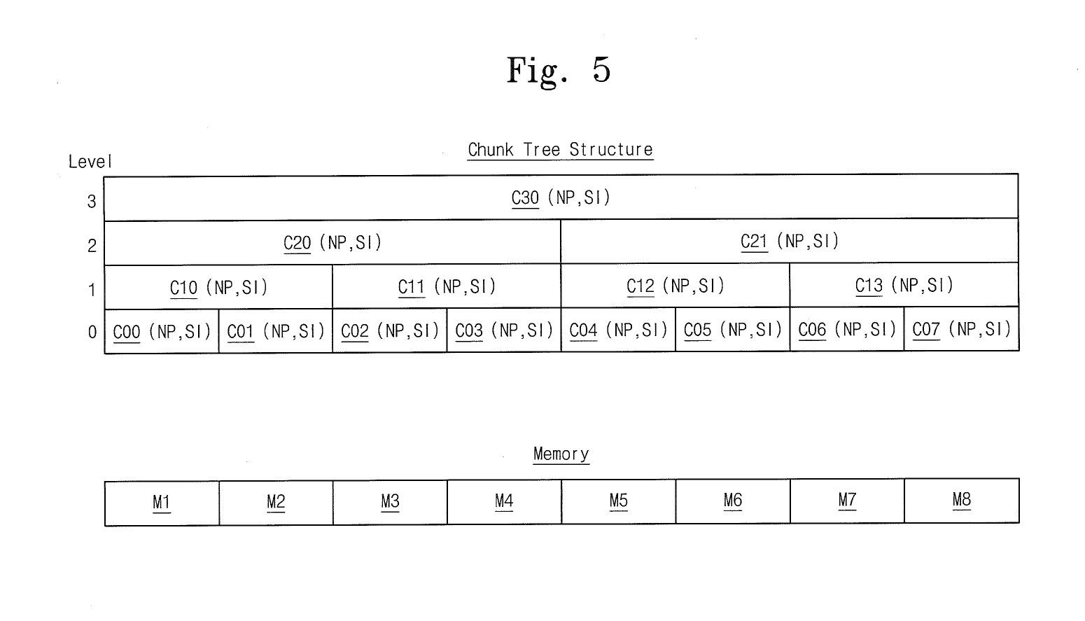

FIG. 5 is a diagram illustrating a memory managing method of a memory manager. Referring to FIGS. 2, 4, and 5, a memory manager 230 may manage memory chunks based on a chunk tree structure, and may manage program frequencies of memory chunks.

A memory 240 may include first to eighth areas M1 to M8. The memory manager 230 may manage the first to eighth areas M1 to M8 of the memory 240 based on a chunk tree structure, and may manage program frequencies of the first to eighth areas M1 to M8, respectively.

The chunk tree structure may be formed of a plurality of levels. A memory chunk C30 corresponding to a third level being the highest level may be a root memory chunk. The root memory chunk C30 may correspond to the first to eighth areas M1 to M8 of the memory 240. For example, if the memory manager 230 allocates the root memory chunk C30 to an operating system 220 or an application 210, all of the first to eighth areas M1 to M8 of the memory 240 may be allocated.

The memory manager 230 may manage information associated with the root memory chunk C30. For example, the memory manager 230 may manage information associated with a program frequency NP and allocation information SI of the root memory chunk C30. The program frequency NP may indicate a wear level of the root memory chunk C30. The allocation information SI may indicate whether the root memory chunk C30 is at an allocated state or not and lower memory chunks of the root memory chunk C30 is at an allocated state.

Memory chunks C20 and C21 at a second level may be child memory chunks of the root memory chunk C30. The root memory chunk C30 may be a parent memory chunk of the memory chunks C20 and C21 at the second level.

The memory chunk C20 may correspond to the first to third areas M1 to M4 of the memory 240, and the memory chunk C21 may correspond to the fifth to eighth areas M5 to M8 of the memory 240. For example, the first to fourth areas M1 to M4 may be allocated when the memory chunk C20 is allocated, and the fifth to eighth areas M5 to M8 may be allocated when the memory chunk C21 is allocated.

The memory manager 230 may manage a program frequency NP and allocation information SI associated with each of the memory chunks C20 and C21.

Memory chunks C10, C11, C12, and C13 at a first level may be child memory chunks of the memory chunks C20 and C21 at the second level. The memory chunk C20 may be a parent memory chunk of the memory chunks C10 and C11, and the memory chunk C21 may be a parent memory chunk of the memory chunks C12 and C13.

The memory chunk C10 may correspond to the first and second areas M1 and M2 of the memory 240, the memory chunk C11 may correspond to the third and fourth areas M3 and M4 of the memory 240, the memory chunk C12 may correspond to the fifth and sixth areas M5 and M6 of the memory 240, and the memory chunk C13 may correspond to the seventh and eighth areas M7 and M8 of the memory 240.

The memory manager 230 may manage a program frequency NP and allocation information SI associated with each of the memory chunks C10 to C13.

Memory chunks C00 and C07 at a 0^{th} level may be child memory chunks of the memory chunks C10 to C13 at the first level. The memory chunk C10 may be a parent memory chunk of the memory chunks C00 and C01, the memory chunk C11 may be a parent memory chunk of the memory chunks C02 and C03, the memory chunk C12 may be a parent memory chunk of the memory chunks C04 and C05, and the memory chunk C13 may be a parent memory chunk of the memory chunks C06 and C07.

The memory chunks C00 to C07 may correspond to the first to eighth areas M1 to M8 of the memory 240, respectively.

The memory manager 230 may manage a program frequency NP and allocation information SI associated with each of the memory chunks C00 to C07.

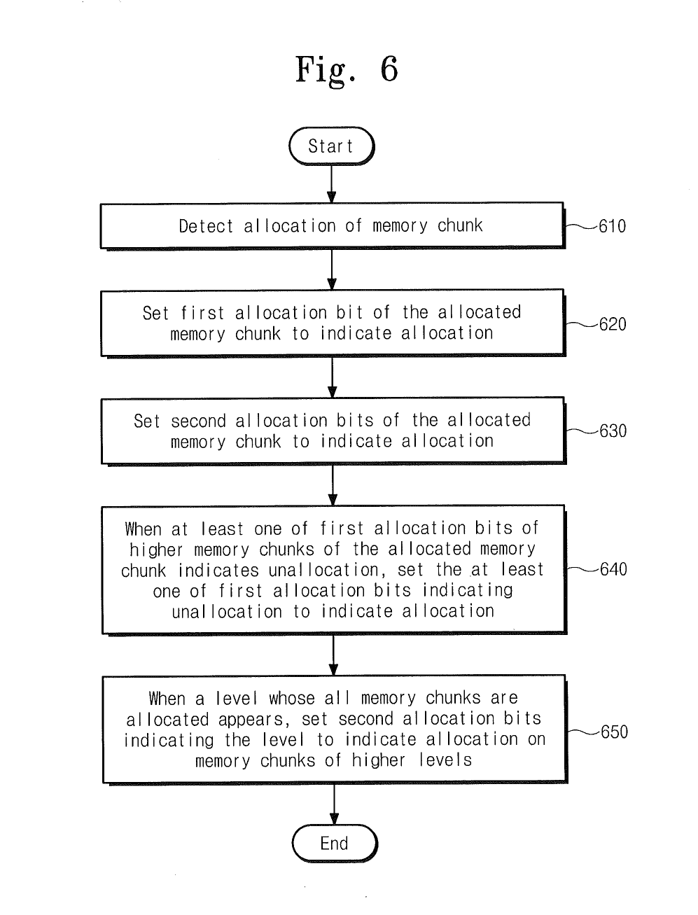

FIG. 6 is a flow chart illustrating a memory managing method of the inventive concept in which memory chunks are managed according to a chunk tree memory. Referring to FIGS. 2, 5, and 6, in operation 610, allocation of a memory chunk may be detected. For example, a memory manager 230 may detect whether a memory chunk is allocated to an operating system 220 or an application 210. The memory manager 230 may allocate the memory chunk. Operation 610 may be performed as a follow-up operation on the allocation of the memory chunk.

In operation 620, the memory manager 230 may set a first allocation bit of the allocated memory chunk so as to indicate allocation. The first allocation bit may be a part of allocation information SI, and may indicate allocation or non-allocation of a related memory chunk. If the first allocation bit is set to allocation, the memory manager 230 may be in use because the related memory chunk is allocated.

In operation 630, the memory manager 230 may set second allocation bits of the allocated memory chunk so as to indicate allocation. The second allocation bits may be a part of the allocation information, and may indicate allocation or non-allocation of lower memory chunks of the related memory chunk. If the second allocation bits are set to allocation, memory chunks pointed by the second allocation bits may be allocated. That is, the memory chunks pointed by the second allocation bits may be in use. The memory manager 230 may set the second allocation bits of the allocated memory chunk to allocation so as to indicate that memory chunks at all lower levels are allocated.

In operation 640, when at least one of first allocation bits of higher memory chunks of the allocated memory chunk indicates non-allocation, the memory manager 230 may set the at least first allocation bit so as to indicate allocation. That is, when one of lower memory chunks is set to allocation, a first allocation bit of allocation information SI of a higher memory chunk may be set to allocation.

In operation 650, if all memory chunks of a level are allocated, second allocation bits indicating a corresponding level in memory chunks of higher levels may be set to allocation under the control of the memory manager 230. For example, if all memory chunks, belonging to the same level, from among lower memory chunks are allocated, a second allocation bit of a higher memory chunk indicating a corresponding level may be set to allocation. In other words, if at least one of lower memory chunks at the same level is at a non-allocation state, a second allocation bit of a higher memory chunk indicating a corresponding level may be set to non-allocation.

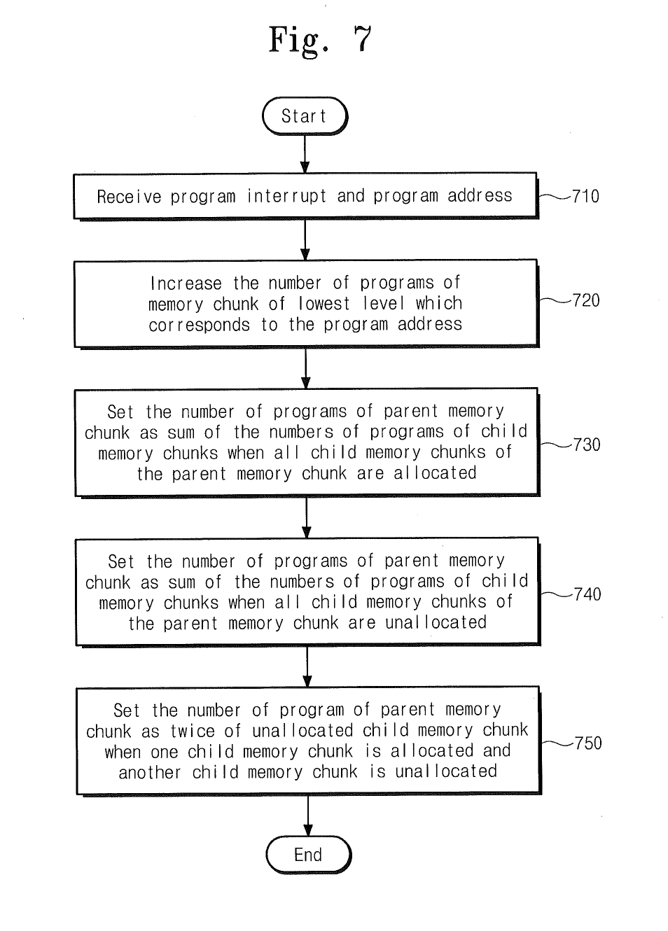

FIG. 7 is a flow chart illustrating a method of managing program frequencies of memory chunks according to a program frequency managing method of the inventive concept.

Referring to FIGS. 1, 2, 5, and 7, in operation 710, program interrupt and a program address may be received. A memory manager 230 executed by a processor 110 or 120 may receive the program interrupt and the program address from a controller 130 of an SCRAM 140. The controller 130 may generate the program interrupt at a program of the SCRAM 140 or when a program of the SCRAM 140 is generated as much as a threshold value. The controller 130 may send the program address causing a generation of the program interrupt together with the program interrupt.

In operation 720, the memory manager 230 may increase a program frequency of a memory chunk at the lowest level corresponding to the program address. For example, the memory manager 230 may increase a program frequency NP of a memory chunk at a 0^{th} level corresponding to the program address.

In operation 730, if all child memory chunks of a parent memory chunk are allocated, the memory manager 230 may set a program frequency NP of the parent memory chunk to a sum of program frequencies NP of the child memory chunks.

In operation 740, if all child memory chunks of the parent memory chunk are at a non-allocation state, the memory manager 230 may set a program frequency NP of the parent memory chunk to a sum of program frequencies NP of the child memory chunks.

In operation 750, if one child memory chunk of the parent memory chunk is allocated and another thereof is at a non-allocation state, the memory manager 230 may set a program frequency NP of the parent memory chunk to a double of a program frequency NP of the child memory chunk not allocated.

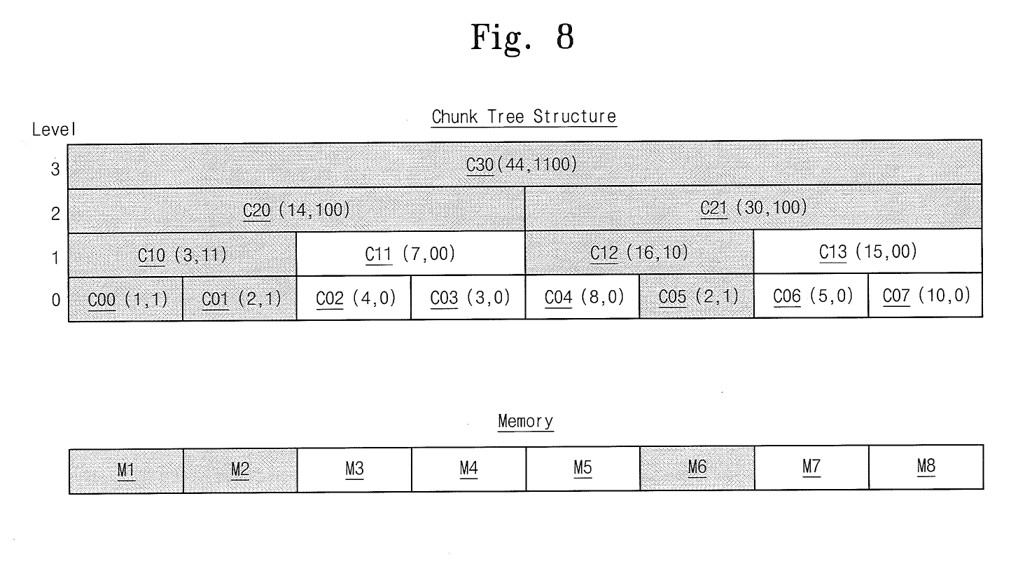

FIG. 8 is a diagram illustrating an example in which memory chunks are managed according to a memory chunk managing method in FIG. 6 and a program frequency managing method in FIG. 7. Referring to FIGS. 6 to 8, memory chunks C00, C01, and C05 may be allocated, and memory chunks C02, C03, C04, C06, and C07 may be released.

Allocation information SI of the memory chunks C00, C01, and C05 may include a value (e.g., 1) indicating allocation. Allocation information SI of the memory chunks C02, C03, C04, C06, and C07 may include a value (e.g., 0) indicating non-allocation. Since the memory chunks C00 to C07 don't have lower memory chunks, each of the memory chunks C00 to C07 may have a first allocation bit indicating whether it is allocated or not. On the other hand, each of the memory chunks C00 to C07 may not have a second allocation bit indicating whether lower memory chunks are allocated or not.

Program frequencies NP of the memory chunks C00 to C07 may be 1, 2, 4, 3, 8, 2, 5, and 10, respectively.

All child memory chunks C00 and C01 of the memory chunk C10 may be allocated. According to operation 640, a first allocation bit of allocation information SI of the memory chunk C10 (i.e., a first bit of the allocation information SI) may have a value (e.g., 1) indicating allocation. According to operation 650, a second allocation bit of the allocation information SI of the memory chunk C10 (i.e., a second bit of the allocation information SI) may have a value (e.g., 1) indicating allocation. Since the memory chunk C10 has a lower level, the second allocation bit of the memory chunk C10 may be formed of a bit corresponding to a 0^{th} level. According to operation 730, a program frequency NP of the memory chunk C10 may be 3 being a sum of program frequencies of the memory chunks C00 and C01.

All child memory chunks C02 and C03 of the memory chunk C11 may be released. This case may not correspond to operation 640. At this time, a first allocation bit of allocation information SI of the memory chunk C11 (i.e., a first bit of the allocation information SI) may have a value (e.g., 0) indicating non-allocation. Also, the above-described case may not correspond to operation 650. At this time, a second allocation bit of the allocation information SI of the memory chunk C11 (i.e., a second bit of the allocation information SI) may have a value (e.g., 0) indicating non-allocation. According to operation 740, a program frequency NP of the memory chunk C11 may be 7 being a sum of program frequencies of the memory chunks C02 and C03.

In the memory chunk C12, a child memory chunk C04 may be released and a child memory chunk C05 may be allocated. According to operation 640, a first allocation bit of allocation information SI of the memory chunk C12 (i.e., a first bit of the allocation information SI) may have a value (e.g., 1) indicating allocation. Also, the above-described case may not correspond to operation 650. At this time, a second allocation bit of the allocation information SI of the memory chunk C12 (i.e., a second bit of the allocation information SI) may have a value (e.g., 0) indicating non-allocation. According to operation 750, a program frequency NP of the memory chunk C12 may be 16 being the double of the program frequency of the child memory chunk C04.

All child memory chunks C06 and C07 of the memory chunk C13 may be released. This case may not correspond to operation 640. At this time, a first allocation bit of allocation information SI of the memory chunk C13 (i.e., a first bit of the allocation information SI) may have a value (e.g., 0) indicating non-allocation. Also, the above-described case may not correspond to operation 650. At this time, a second allocation bit of the allocation information SI of the memory chunk C13 (i.e., a second bit of the allocation information SI) may have a value (e.g., 0) indicating non-allocation. According to operation 740, a program frequency NP of the memory chunk C11 may be 15 being a sum of program frequencies of the memory chunks C06 and C07.

Memory chunks C10, C00, and C01 of lower memory chunks of the memory chunk C20 may be allocated. According to operation 640, a first allocation bit of allocation information SI of the memory chunk C20 (i.e., a first bit of the allocation information SI) may have a value (e.g., 1) indicating allocation. A level, in which all memory chunks are allocated, from among lower levels of the memory chunks C20 may not exist. In this case, a second allocation bit indicating a first level (i.e., a second bit of the allocation information SI) and a second allocation bit indicating a 0^{th} level (i.e., a third bit of the allocation information SI) may have a value (e.g., 0) indicating non-allocation. According to operation 750, a program frequency NP of the memory chunk C20 may be 14 being the double of the program frequency NP of one C11, not allocated, from among the child memory chunks C10 and C11.

Memory chunks C12 and C05 of lower memory chunks of the memory chunk C21 may be allocated. According to operation 640, a first allocation bit of allocation information SI of the memory chunk C21 (i.e., a first bit of the allocation information SI) may have a value (e.g., 1) indicating allocation. A level in which all memory chunks are allocated from among lower levels of the memory chunks C20 may not exist. Since this case not correspond to operation 650, a second allocation bit indicating a first level (i.e., a second bit of the allocation information SI) and a second allocation bit indicating a 0^{th} level (i.e., a third bit of the allocation information SI) may have a value (e.g., 0) indicating non-allocation. According to operation 750, a program frequency NP of the memory chunk C21 may be 30 being the double of the program frequency NP of one C13, not allocated, from among the child memory chunks C12 and C13.

A first allocation bit of a root memory chunk C30 (i.e., a first bit of allocation information SI) may have a value (e.g., 1) indicating allocation. Since all lower memory chunks C20 and C21 at a second level are allocated, a second allocation bit indicating the second level (i.e., a second bit of the allocation information SI) may have a value (e.g., 1) indicating allocation. Second allocation bits indicating a first level and a 0^{th} level (i.e., third and fourth bits of the allocation information SI) may have values (e.g., 0) indicating non-allocation, respectively.

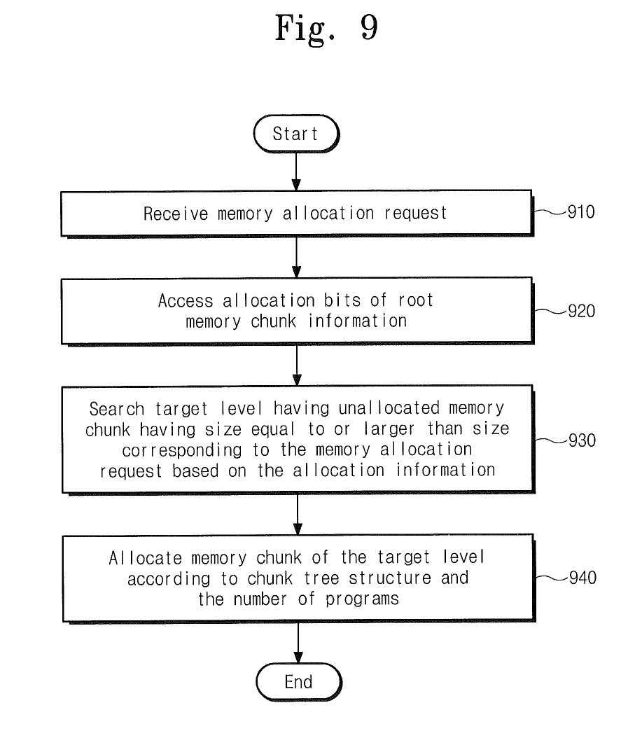

FIG. 9 is a flow chart indicating a memory chunk allocating method according to an embodiment of the inventive concept. Referring to FIGS. 2 and 9, in operation 910, a memory manager 230 may receive a memory allocation request from an operating system 220.

In operation 920, the memory manager 230 may access allocation information SI of a root memory chunk.

In operation 930, the memory manager 230 may search a target level, including an unallocated memory chunk having a size equal to or larger than a size corresponding to the memory allocation request, based on the allocation information SI of the root memory chunk.

In operation 940, the memory manager 230 may allocate a memory chunk of the target level according to a chunk tree structure and program frequencies NP of memory chunks.

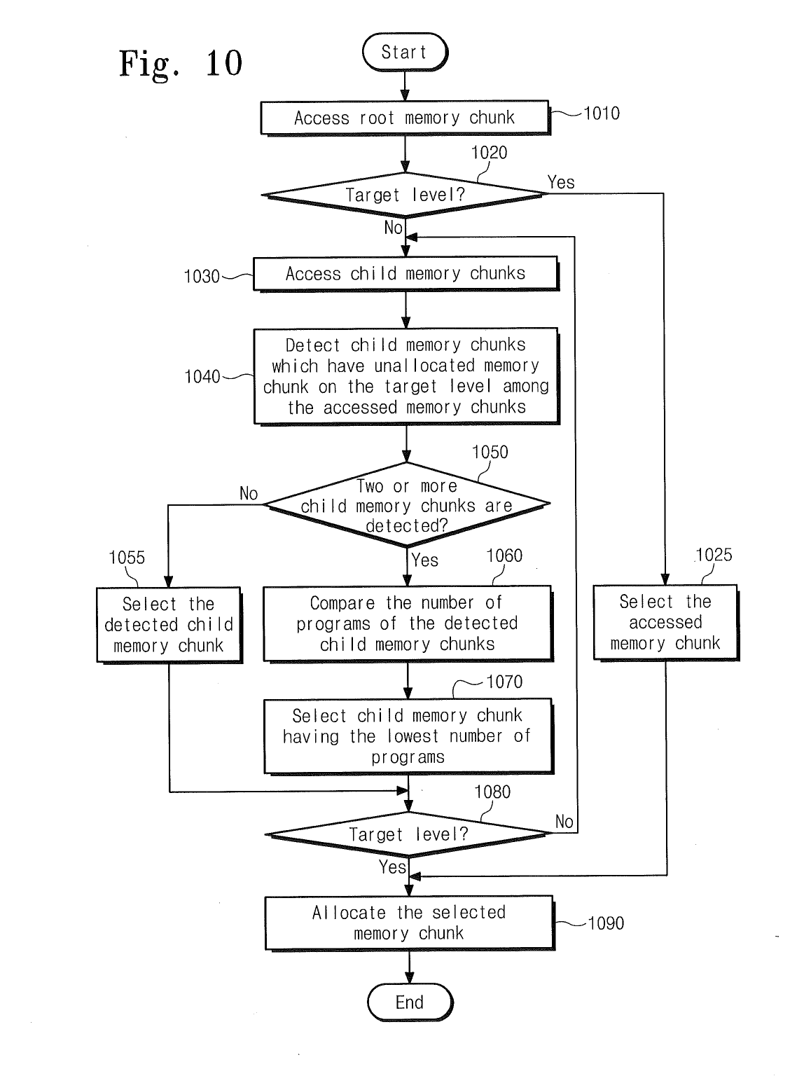

FIG. 10 is a detailed flow chart indicating a method of allocating a memory chunk of a target level in FIG. 9. Referring to FIGS. 2 and 10, in operation 1010, a memory manager 230 may access a root memory chunk.

In operation 1020, the memory manager 230 may determine whether a level to which the accessed memory chunk belongs is a target level. If so, in operation 1025, the accessed memory chunk may be selected, and the method proceeds to operation 1090. If not, the method proceeds to operation 1030.

In operation 1030, the memory manager 230 may access child memory chunks of the accessed memory chunk.

In operation 1040, the memory manager 230 may detect child memory chunks, having a memory chunk not allocated to the target level, from among accessed child memory chunks.

In operation 1050, the memory manager 230 may determine whether two or more child memory chunks are detected. If not, in operation 1055, the detected child memory chunk may be selected, and the method proceeds to operation 1080. If so, the method proceeds to operation 1060.

In operation 1060, the memory manager 230 may compare program frequencies NP of the detected child memory chunks.

In operation 1070, the memory manager 230 may select a child memory chunk having the lowest program frequency NP.

In operation 1080, the memory manager 230 may determine whether the selected memory chunk belongs to the target level. If not, the method proceeds to operation 1030. If so, the method proceeds to operation 1090, in which the memory manager 230 allocates the selected memory chunk.

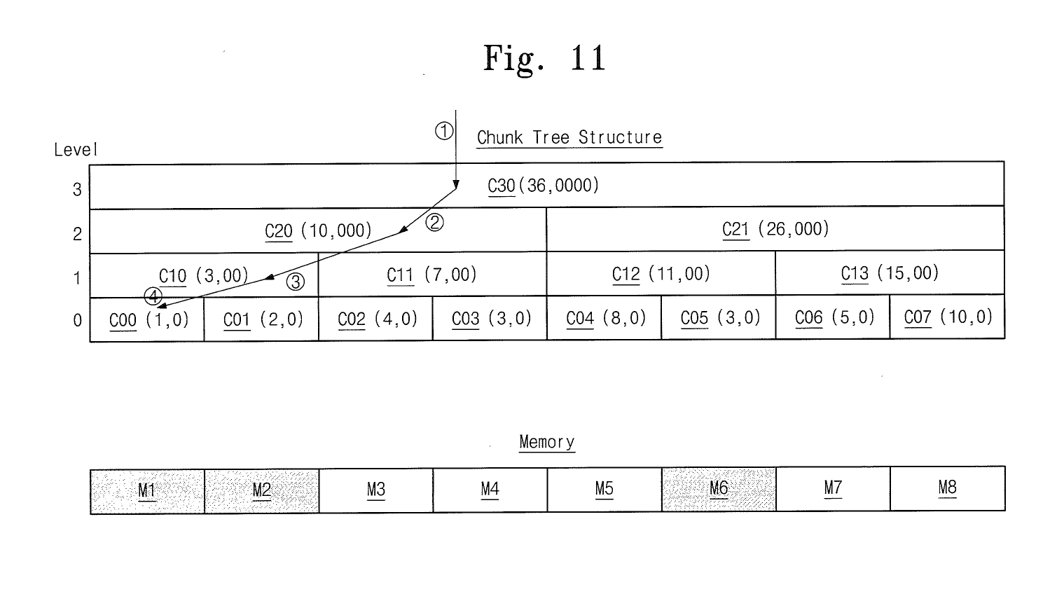

FIGS. 11 to 16 are diagrams illustrating an example in which memory chunks are allocated and released according to a chunk tree managing method in FIG. 6, a program frequency managing method in FIG. 7, and a memory chunk allocating method in FIG. 10. Referring to FIG. 11, since all memory chunks C00 to C06, C10 to C13, C20, C21, and C30 are released, they may have program frequencies NP as illustrated in FIG. 11.

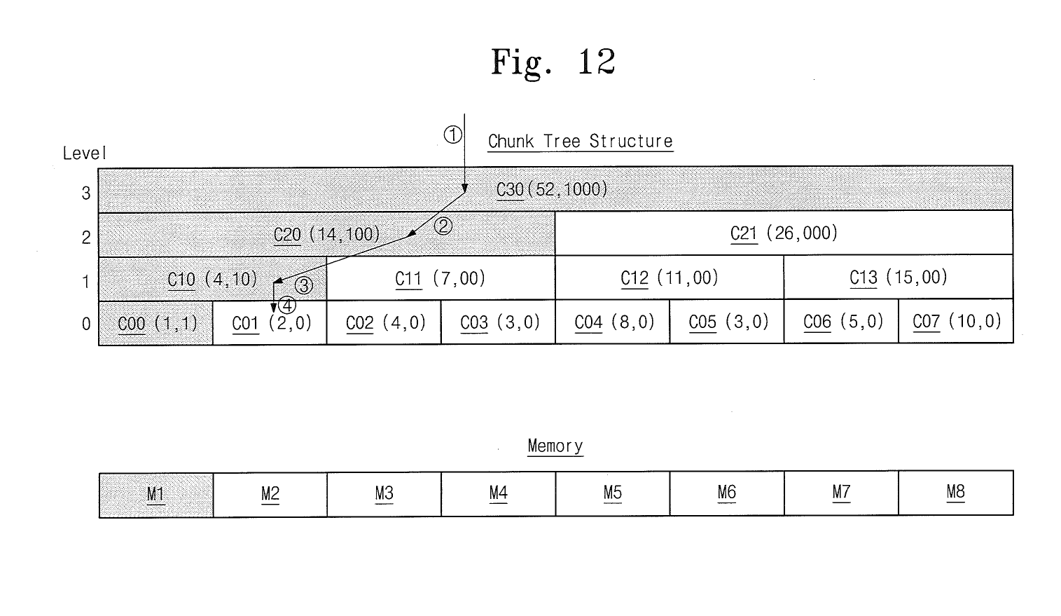

In FIG. 12, there is illustrated a process in which memory chunks in FIG. 11 are allocated according to a memory allocation request. In example embodiments, a memory allocation request may request a memory chunk having a size corresponding to memory chunks C00 to C07 at a 0^{th} level.

Referring to FIGS. 2 and 11, a memory manager 230 may access allocation information SI of a root memory chunk C30. A fourth bit of the allocation information SI of the root memory chunk C30 may be a second allocation bit indicating whether memory chunks at a 0^{th} level are allocated or not. The second allocation bit may indicate that a memory chunk, having a release state, from among the memory chunks at the 0^{th} level exists. Thus, the 0^{th} level may be selected as the target level.

The root memory chunk C30 may be accessed (\textcircled{2}).

Since the root memory chunk C30 does not belong to the target level, the memory manager 230 may access child memory chunks C20 and C21 of the root memory chunk C30. A program frequency NP of the memory chunk C20 may be 10, and a program frequency NP of the memory chunk C21 may be 26. Thus, the memory manager 230 may select the memory chunk C20 (\textcircled{2}).

Since the selected memory chunk C20 does not belong to the target level, the memory manager 230 may access child memory chunks C10 and C11 of the selected memory chunk C20. A program frequency NP of the memory chunk C10 may be 3, and a program frequency NP of the memory chunk C11 may be 7. Thus, the memory manager 230 may select the memory chunk C10 (\textcircled{3}).

Since the selected memory chunk C10 does not belong to the target level, the memory manager 230 may access child memory chunks C00 and C01 of the selected memory chunk C10. A program frequency NP of the memory chunk C00 may be 1, and a program frequency NP of the memory chunk C01 may be 2. Thus, the memory manager 230 may select the memory chunk C00 (\textcircled{4}).

Since the selected memory chunk C00 belongs to the target level, the memory manager 230 may allocate the selected memory chunk C00. As the memory chunk C00 is allocated, a first area M1 of a memory 240 corresponding to the memory chunk C00 may be allocated.

An allocation result of the memory chunk C00 may be illustrated in FIG. 12. A first allocation bit of allocation information SI of the allocated memory chunk C00 (i.e., a first bit of the allocation information SI) may be set to a value (e.g., 1) indicating allocation. First allocation bits of upper memory chunks C10, C20, and C30 of the allocated memory chunk C00 (i.e., a first bit of the allocation information SI) may be set to a value (e.g., 1) indicating allocation. If the memory chunk C00 is allocated, a part of storage capacities of the upper memory chunks C10, C20, and C30 may be used. For example, the upper memory chunks C10, C20, and C30 of the allocated memory chunk C00 may not be allocated in itself. Thus, the first allocation bits of the upper memory chunks C10, C20, and C30 may be set to a value (e.g., 1) indicating allocation.

A program frequency NP of the memory chunk C10 may be set to 4 being the double of the program frequency NP of the child memory chunk C01 released. A program frequency NP of the memory chunk C20 may be set to 14 being the double of the program frequency NP of the child memory chunk C11 released. A program frequency NP of the root memory chunk C30 may be set to 52 being the double of the program frequency NP of the child memory chunk C21 released.

Later, a memory allocation request corresponding to memory chunks C00 to C07 at a 0^{th} level may be again received. The memory manager 230 may determine whether a memory chunk, being at a release state, from among the memory chunks C00 to C07 at the 0^{th} level exists, based on allocation information SI of the root memory chunk C30. The memory manager 230 may set the 0^{th} level to the target level.

Referring to a third bit of the allocation information SI, memory chunks C20 and C21 may have memory chunks having a release state at the 0^{th} level, respectively. Since a program frequency NP of the memory chunk C20 is lower than that of the memory chunk C21, the memory chunk C20 may be selected (\textcircled{2}).

Referring to a second bit of the allocation information SI, memory chunks C10 and C11 may have memory chunks having a release state at the 0^{th} level, respectively. The memory chunk C10 having a relatively low program frequency NP may be selected (\textcircled{3}).

The memory chunk C00 may be at an allocation state, and the memory chunk C01 may be at a non-allocation state. Thus, the memory chunk C01 may be allocated (\textcircled{4}). In this case, a second area M2 of the memory may be allocated.

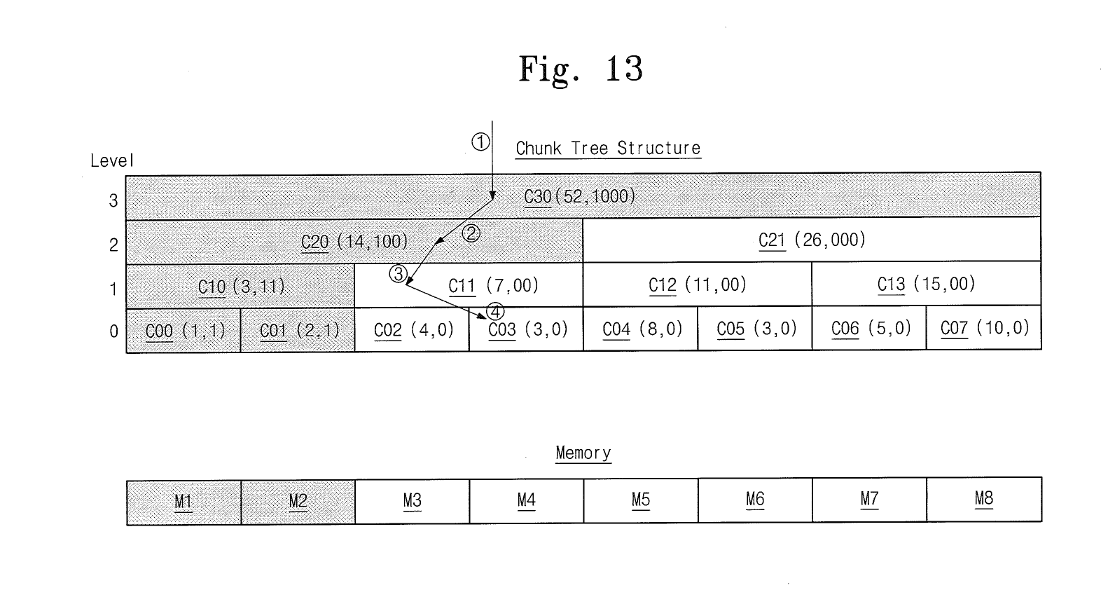

An allocation result of the memory chunk C01 may be illustrated in FIG. 13. A first allocation bit of allocation information SI of the allocated memory chunk C01 (i.e., a first bit of the allocation information SI) may be set to 1 indicating allocation. Since all lower memory chunks C00 and C01 at the 0^{th} level being a lower level of the memory chunk C10 are allocated, a second allocation bit (i.e., a second bit of the allocation information SI), indicating the 0^{th} level of the allocation, of the allocation information SI of the memory chunk C10 may be set to 1 indicating allocation. A program frequency NP of the memory chunk C10 may be set to 3 being a sum of program frequencies of the memory chunks C00 and C01.

Later, a memory allocation request corresponding to the memory chunks C00 to C07 at the 0^{th} level may be again received. The memory manager 230 may set the 0^{th} level to the target level based on the allocation information SI of the root memory chunk C30.

One C20 of the memory chunks C20 and C21 may be selected according to a program frequency NP (\textcircled{2}).

Referring to a second allocation bit of the allocation information SI (i.e., a second bit of the allocation information SI) indicating the 0^{th} level, the memory chunk C10 may not have a memory chunk having a release state at the 0^{th} level. Thus, the memory chunk C11 may be selected (\textcircled{3}).

A memory chunk C03 of the memory chunks C02 and C03 may be allocated according to a program frequency (\textcircled{4}). In this case, a fourth area M4 of the memory 240 may be allocated.

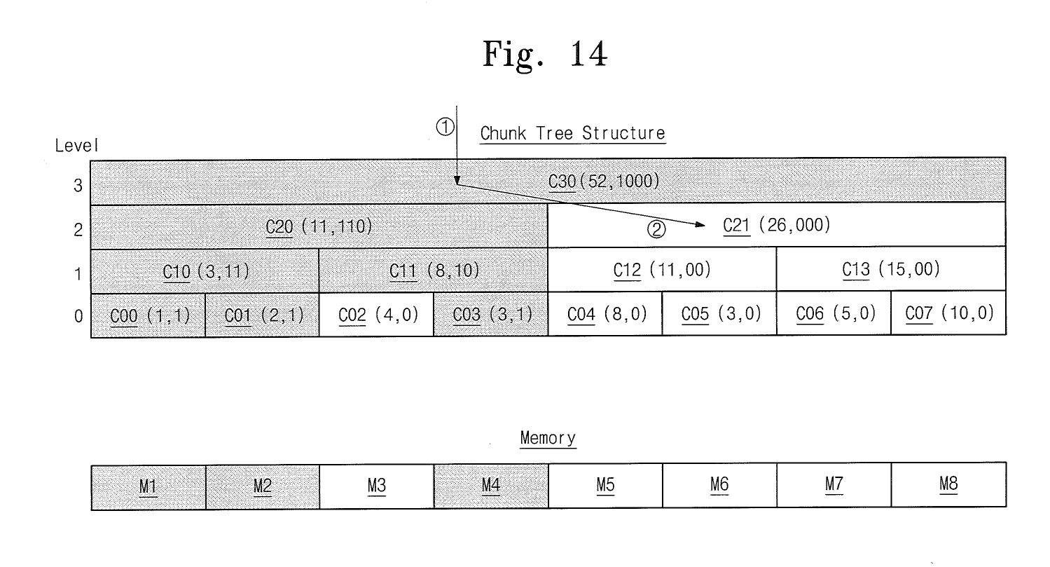

An allocation result of the memory chunk C03 may be illustrated in FIG. 14. A first allocation bit of the allocation information SI of the allocated memory chunk C03 (i.e., a first bit of the allocation information SI) may be set to 1 indicating allocation. A first allocation bit of the allocation information SI (i.e., a first bit of the allocation information SI) of an upper memory chunk C11 of the memory chunk 03 may be set to 1 indicating allocation. Since all lower memory chunks C10 and C11 at the first level being a lower level are allocated, a second allocation bit (i.e., a second bit) of the allocation information SI of the memory chunk C20 may be set to 1 indicating allocation. A program frequency NP of the memory chunk C11 may be set to 8 being the double of the program frequency NP of a child memory chunk C02 released. A program frequency NP of the memory chunk C20 may be set to 11 being a sum of program frequencies NP of child memory chunks C10 and C11.

Afterwards, a memory allocation request corresponding to the memory chunks C20 and C21 at the second level may be again received. The memory manager 230 may set the second level to the target level based on allocation information SI of the root memory chunk C30.

Since a first allocation bit (i.e., a first bit) of the allocation information SI of the memory chunk C20 indicates allocation, the memory chunk C21 may be allocated (\textcircled{2}). In this case, fifth to eighth areas M5 to M8 of the memory 240 may be allocated.

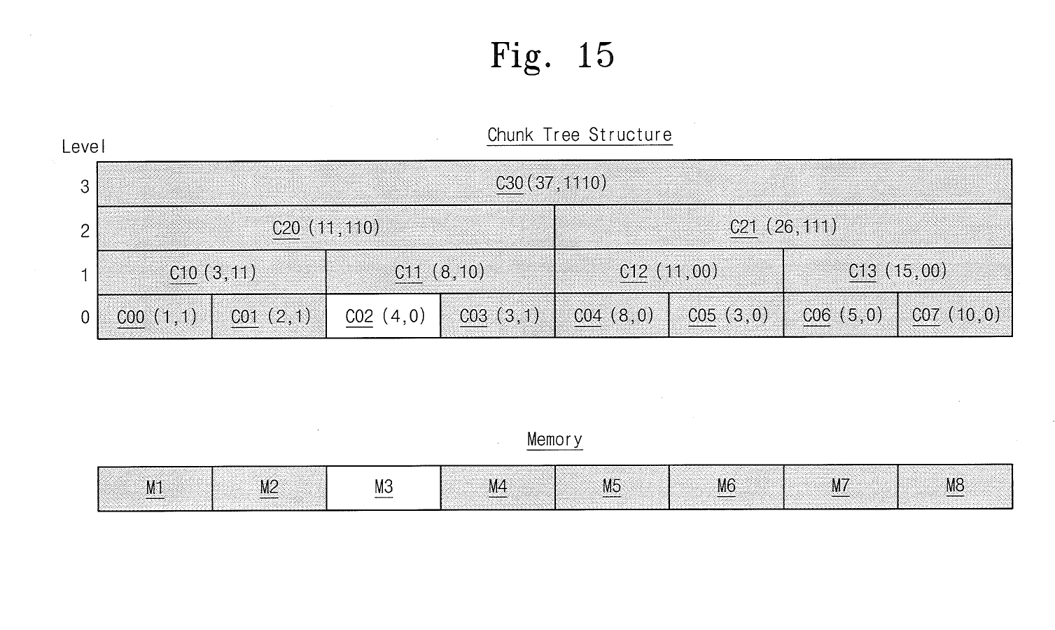

An allocation result of the memory chunk C03 may be illustrated in FIG. 15. A first allocation bit of the allocation information SI of the allocated memory chunk C21 may be set to 1 indicating allocation. Second allocation bits (i.e., second and third bits) of the allocation information SI of the allocated memory chunk C21 may be set to 1 indicating allocation (operation 630). That is, the allocation information SI of the allocated memory chunk C21 may be set to indicate that lower memory chunks C12, C13, C04, C05, C06, and C07 of the allocated memory chunk C21 are not allocated.

Since all of the memory chunks C20 and C21 at the second and third levels are allocated, a second allocation bit (i.e., a second bit) of the allocation information SI of the root memory chunk C30 indicating the second level and a third allocation bit (i.e., a third bit) of the allocation information SI of the root memory chunk C30 indicating the third level may be set to 1 indicating allocation.

A program frequency NP of the memory chunk C30 may be set to 37 being a sum of program frequencies of child memory chunks C20 and C21.

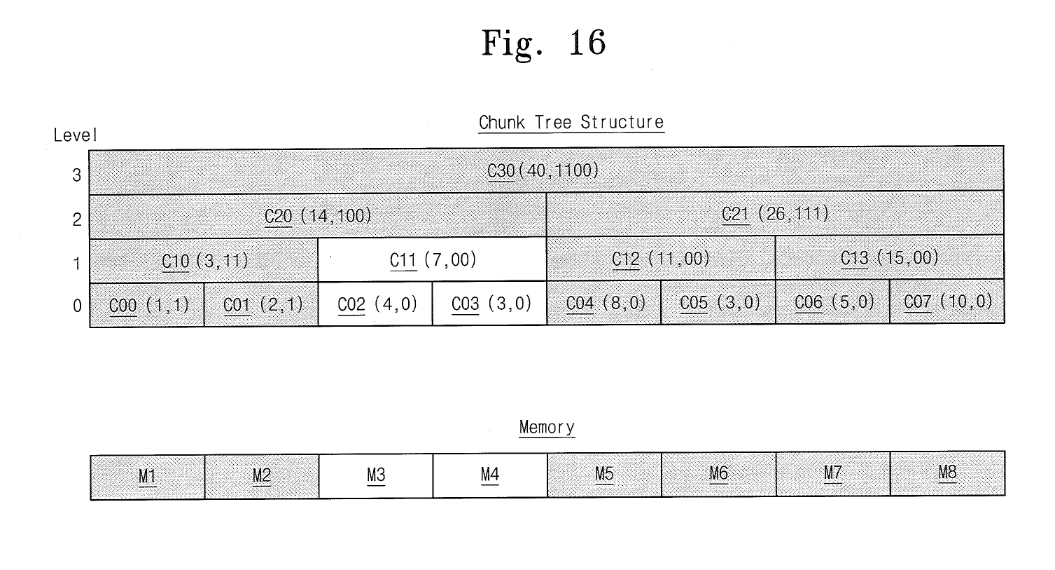

Afterwards, a release request on the allocated memory chunks may be received. For example, a release request on the memory chunk C03 may be received. As the memory chunk C03 is released, the fourth area M4 of the memory 240 may be released. A released result of the memory chunk C03 may be illustrated in FIG. 16.

A first allocation bit (i.e., a first bit) of the allocation information SI of the released memory chunk C03 may be set to 0 indicating non-allocation. A second allocation bit (i.e., a second bit) of the allocation information SI of the memory chunk C20 indicating the first level may be set to 0 indicating non-allocation.

A program frequency NP of the memory chunk C11 may be set to 7 being a sum of program frequencies NP of child memory chunks C02 and C03. A program frequency NP of the memory chunk C20 may be set to 14 being the double of the program frequency of a child memory chunk C11 released.

As described with reference of FIGS. 11 to 16, program frequencies NP and allocation information SI of memory chunks may be dynamically managed according to allocation and release of the memory chunks. Program frequencies NP of memory chunks C00 to C07 at the lowest level may increase according to a program interrupt and a program address. Program frequencies NP of memory chunks at an upper level may be managed according to program frequencies NP of memory chunks at a lower level and whether the memory chunks at the lower level are allocated or not.

In the memory chunks C00 to C07 at the lowest level, allocation information SI may include a first allocation bit, and may be adjusted according to whether they themselves are allocated. A first allocation bit of allocation information SI of a parent memory chunk may be adjusted whether it itself is allocated and whether a lower memory chunk is allocated. Second allocation bits of the allocation information SI of the parent memory chunk may be set to logical conjunction (AND) of allocation information SI of child memory chunks.

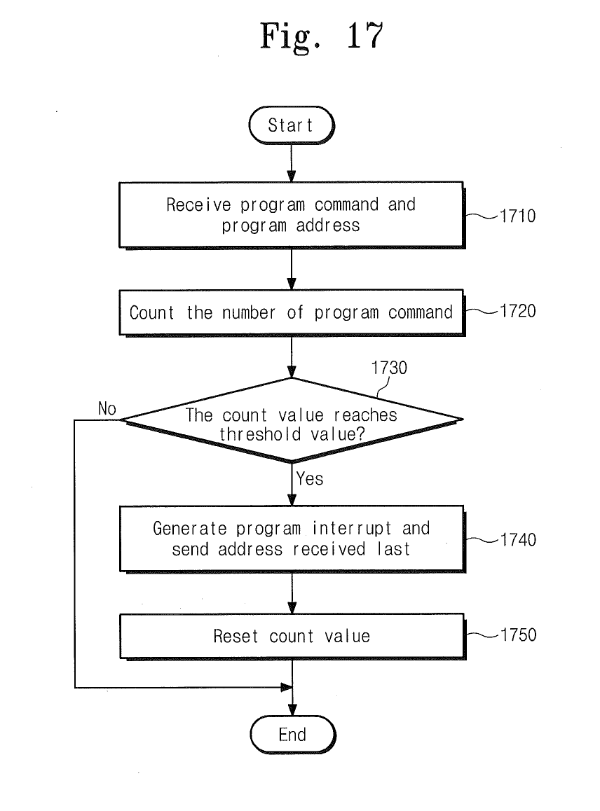

FIG. 17 is a flow chart illustrating an embodiment of a method in which a controller in FIG. 1 transfers a program interrupt and a program address. Referring to FIGS. 1 and 17, a controller may receive a program command and a program address (operation 1710).

In operation 1720, the controller 130 may count a program command frequency using a counter CNT.

In operation 1730, the controller 130 may determine whether a count value reaches a threshold value. If the count value reaches the threshold value, in operation 1740, the controller 130 may generate a program interrupt to transfer a program address.

In operation 1750, the controller 130 may reset the count value.

When a program of an SCRAM 140 is performed by a frequency corresponding to the threshold value, the controller 130 may transfer a program address corresponding to a program command reaching the threshold value and the program interrupt. That is, the controller 130 may sample a program address of the SCRAM 140 based on the threshold value, and may increase program frequencies of memory chunks C00 to C07 at the lowest level according to the sampled program address. If wear levels of the memory chunks C00 to C07 at the lowest level are performed, complexity of managing of wear levels may be reduced.

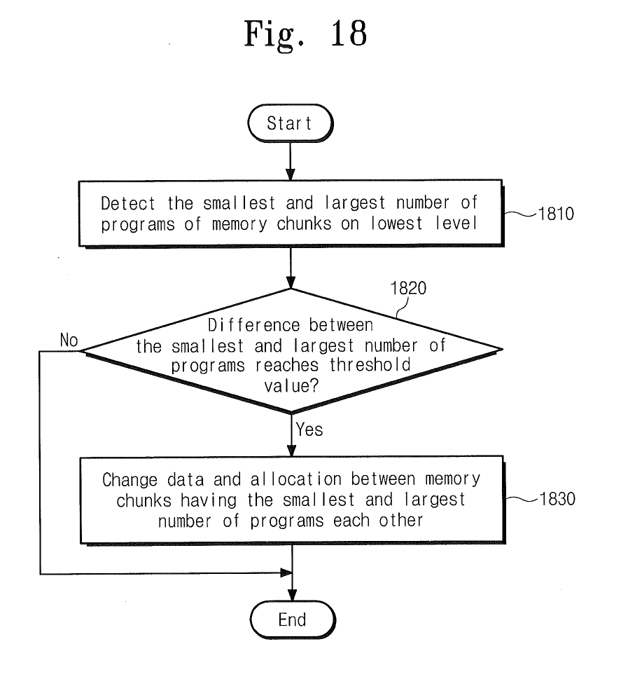

FIG. 18 is a flow chart illustrating an embodiment in which wear levels of allocated memory chunks are managed. Referring to FIGS. 2 and 18, in operation 1810, a memory manager 230 may detect memory chunks at the lowest level having the smallest program frequency and the largest program frequency.

In operation 1820, the memory manager 230 may determine whether a difference between the smallest program frequency and the largest program frequency reaches a threshold value. If so, in operation 1830, the memory manager 230 may change data and allocation between memory chunks having the smallest program frequency and the largest program frequency each other.

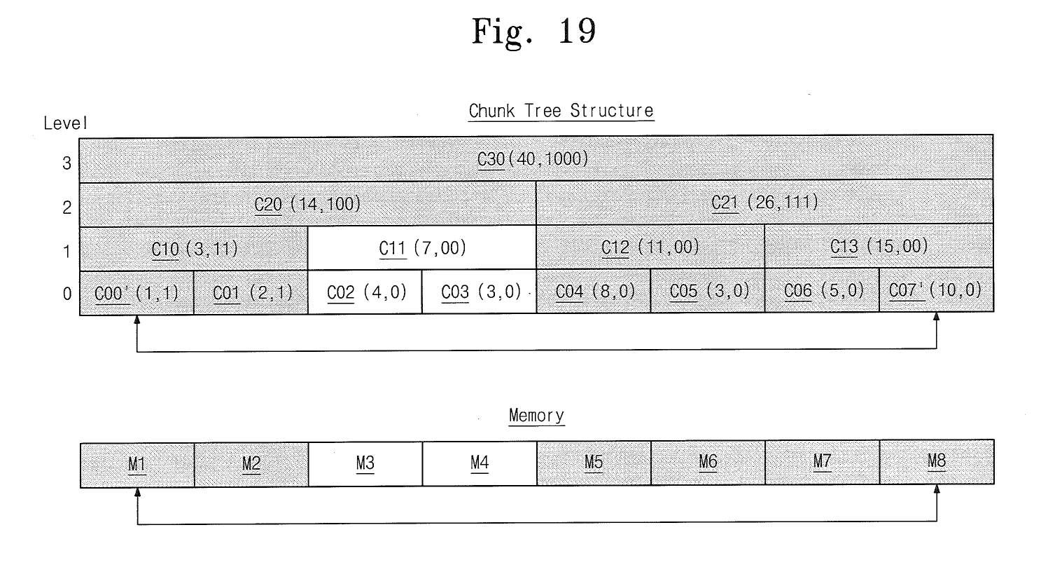

FIG. 19 is a diagram illustrating an example in which a wear level is managed according to a managing method in FIG. 18. Referring to FIGS. 18 and 19, a memory chunk C00 at the lowest level may have the smallest program frequency, and a memory chunk C07 may have the largest program frequency. It is assumed that a difference between the smallest program frequency and the largest program frequency reaches a threshold value.

A memory manager 230 may exchange data of the memory chunk C00 and data of the memory chunk C07. The memory manager 230 may exchange allocation of the memory chunks C00 and C07 to each other.

Data stored in the memory chunk C00 may be copied to the memory chunk C07, and data stored in the memory chunk C07 may be copied to the memory chunk C00. The memory chunk C00 corresponding to a first area M1 of a memory 240 may be exchanged with a child memory chunk C07′ of a memory chunk C13. The memory chunk C07 corresponding to an eighth area M8 of the memory 240 may be exchanged with a child memory chunk C00′ of a memory chunk C10.

With embodiments of the inventive concept, although a program may be continuously generated with a specific memory chunk being occupied, it is possible to prevent the specific memory chunk from being continuously worn.

As described above, a memory may be allocated in view of a memory chunk tree structure and program frequencies of memory chunks. Thus, it is possible to improve the reliability and life of an SCRAM-based memory system.

While the inventive concept has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A method of managing a memory including a plurality of memory chunks according to a chunk tree structure, comprising:
managing program frequencies of the plurality of memory chunks of the memory according to a program of the memory;
managing allocation information of ones of the plurality of memory chunks in the chunk tree structure; and
allocating the plurality of memory chunks based on the program frequencies and the allocation information.

2. The method of claim 1, wherein managing the program frequencies of the plurality of memory chunks comprises:
receiving a program interrupt and a program address from a memory controller that controls the memory; and
increasing a program frequency of the lowest memory chunk corresponding to the program address.

3. The method of claim 2, wherein the program interrupt and the program address are received when a program frequency of the memory reaches a threshold value, and
wherein the program address corresponds to a program executed when the program frequency of the memory reaches the threshold value.

4. The method of claim 2,
wherein the plurality of memory chunks includes a parent memory chunk and a plurality of child memory chunks, and
wherein managing the program frequencies of the plurality of memory chunks further comprises:
setting a program frequency of the parent memory chunk to a sum of program frequencies of the child memory chunks.

5. The method of claim 2,
wherein the plurality of memory chunks includes a parent memory chunk and a plurality of child memory, and
wherein managing the program frequencies of the plurality of memory chunks further comprises:
setting a program frequency of the parent memory chunk to a sum of program frequencies of a non-allocated one of the plurality of child memory chunks.

6. The method of claim 2,
wherein the plurality of memory chunks includes a parent memory chunk and a plurality of child memory chunks,
wherein managing the program frequencies of the plurality of memory chunks further comprises:
setting a program frequency of the parent memory chunk to double the program frequency of a non-allocated one of the plurality of child memory chunks.

7. The method of claim 2, wherein managing the program frequencies of the plurality of memory chunks comprises:
detecting a smallest program frequency and a largest program frequency of program frequencies of the plurality of memory chunks at a lowest level of the chunk tree structure;
determining whether a difference between the smallest program frequency and the largest program frequency reaches a threshold value; and
if the difference between the smallest program frequency and the largest program frequency reaches the threshold value, exchanging data and allocation between memory chunks having the smallest program frequency and the largest program frequency.

8. The method of claim 1, wherein managing allocation information of ones of the plurality of memory chunks in the chunk tree structure comprises:
detecting allocation of at least one memory chunk of the plurality of memory chunks; and
setting a first allocation bit associated with the allocated memory chunk to indicate allocation,
wherein the first allocation bit of each of the plurality of memory chunks indicates whether an associated one of the plurality of memory chunks is allocated.

9. The method of claim 8, wherein managing allocation information of ones of the plurality of memory chunks in the chunk tree structure further comprises:
setting a second allocation bit of the allocated memory chunk,
wherein the second allocation bit of the associated one of the plurality of memory chunks indicates whether all memory chunks at each of lower levels relative to the associated memory chunk are allocated.

10. The method of claim 8, wherein managing allocation information of ones of the plurality of memory chunks in the chunk tree structure further comprises:
setting at least one first allocation bit of an upper memory chunk to allocation when the at least one of first allocation bits associated with the upper memory chunks of the allocated memory chunk indicates non-allocation.

11. The method of claim 9, wherein managing allocation information of ones of the plurality of memory chunks in the chunk tree structure further comprises:
when all memory chunks at one level of the chunk tree structure are allocated, setting second allocation bits indicating the level including the memory chunks allocated to indicate allocation at upper memory chunks relative to the level, and
wherein each of second allocation bits of the plurality of memory chunks indicates whether all memory chunks at each of lower levels associated with a corresponding memory chunk are allocated.

12. The method of claim 1, further comprising:
receiving a memory allocation request;
accessing allocation bits associated with a root memory chunk, located at a highest level, from among the plurality of memory chunks;
searching a target level, including an unallocated memory chunk having a size equal to or larger than a size corresponding to the memory allocation request, from among levels of the chunk tree structure based on the allocation bits; and
allocating a memory chunk at the target level according to the chunk tree structure and the program frequencies.

13. The method of claim 12, wherein the allocating the memory chunk at the target level according to the chunk tree structure and the program frequencies comprises:
allocating the unallocated memory chunk when an unallocated memory chunk exists at the target level; and
when two or more unallocated memory chunks exist at the target level, sequentially selecting a child memory chunk, having an allocation bit indicating that an unallocated memory chunk exists at the target level and that includes a small program frequency relative to other memory chunks at the same level until reaching the target level from the root memory chunk and allocating a memory chunk selected at the target level.

14. A memory system comprising:
a memory;
a controller configured to control the memory; and
a processor configured to manage the memory according to a chunk tree structure,
wherein the controller is configured to generate a program interrupt whenever a program of the memory is performed by a threshold value; and
wherein the processor is configured to manage program frequencies of a plurality of memory chunks of the memory based on the program interrupt and to allocate the plurality of memory chunks based on the chunk tree structure and the program frequencies.

15. A method of managing a memory by a unit of memory chunk, comprising:
managing a plurality of memory chunks according to a chunk tree structure;
managing program frequencies of the plurality of memory chunks of the memory according to a program of the memory; and
allocating the plurality of memory chunks based on the program frequencies and the chunk tree structure.

16. The method of claim 15, wherein managing the program frequencies of the plurality of memory chunks of the memory according to a program of the memory further comprises:
setting a program frequency of a parent memory chunk, in which all child memory chunks are allocated, from among the plurality of memory chunks to a sum of program frequencies of the child memory chunks.

17. The method of claim 15, wherein managing the program frequencies of the plurality of memory chunks of the memory according to a program of the memory further comprises:
setting a program frequency of a parent memory chunk, in which a first child memory chunk is allocated and a second child memory chunk is not allocated, from among the plurality of memory chunks to the double of the program frequency of the second child memory chunk not allocated.

18. The method of claim 15, wherein managing the program frequencies of the plurality of memory chunks of the memory according to a program of the memory comprises:
detecting the smallest program frequency and the largest program frequency of program frequencies of memory chunks at the lowest level of the chunk tree structure;
determining whether a difference between the smallest program frequency and the largest program frequency reaches a threshold value; and
if the difference between the smallest program frequency and the largest program frequency reaches the threshold value, exchanging data and allocation between memory chunks having the smallest program frequency and the largest program frequency.

19. The method of claim 15, wherein managing the plurality of memory chunks according to a chunk tree structure comprises:
detecting allocation of at least one memory chunk of the plurality of memory chunks; and
setting a first allocation bit associated with the allocated memory chunk to indicate allocation,
wherein a first allocation bit of each of the plurality of memory chunks indicates whether an associated memory chunk is allocated.

20. The method of claim 19, wherein managing the plurality of memory chunks according to a chunk tree structure further comprises:
setting second allocation bits of the allocated memory chunk, and
wherein each of second allocation bits of the plurality of memory chunks indicates whether all memory chunks at each of lower levels associated with a corresponding memory chunk are allocated.
